(19) United States
(12) Patent Application Publication
(10) Pub. No.: US 2008/0162353 A1
(43) Pub. Date: Jul. 3, 2008

(54) PERSONAL DIGITAL RIGHTS MANAGEMENT AGENT-SERVER

(75) Inventors: Joe Yuen Tom, Foster City, CA (US); Jeremy Isaac Nathaniel Werner, San Jose, CA (US); Russell Barck, San Jose, CA (US)

Correspondence Address: AMIN, TUROCY & CALVIN, LLP, 1900 EAST NINTH STREET, 24TH FLOOR, NATIONAL CITY CENTER, CLEVELAND, OH, 44114, US

(73) Assignee: SPANSION LLC, Sunnyvale, CA (US)

(21) Appl. No.: 11/616,385

(22) Filed: Dec. 27, 2006

(51) Int. Cl. H04L 9/00

(52) U.S. Cl. 705/51

(57) ABSTRACT

Systems and methods that facilitate the management of digital content in a local environment between a limited number of parties. A digital rights management (DRM) agent-server can be created in hardware in which both the agent-server and agent are trusted. A content owner can send digital content along with a rights attachment indicating a scope of the use rights associated with the content. The content can be accessed by the agent and perceived in a presentation component that will only permit the agent to use the content in accordance with the rights granted as to the content. The DRM agent-server can be implemented by an application-specific integrated circuit (ASIC). Further, the DRM agent-server can be implemented on a portable electronic device such as a cellular phone, a personal digital assistant (PDA), or a laptop computer, for example.

### BACKGROUND

Digital content, such as music, video or photographs, is often copied from one platform to another without the consent of the digital content owner. For example, when an owner of a digital copy of a photograph sends that photograph to a client electronic device (e.g., a computer, an MP3 player, an iPod®, a cellular phone, a personal digital assistant (PDA), a portable media player, etc.) of another, that photograph can then be sent to yet another electronic device without the consent of the original owner.

Often, the owner of digital content may wish to share such digital content with another by sending it from an electronic device of the owner to another electronic device of another person. However, the owner may intend/desire to prevent the other person from sending the received digital content to a third entity and/or may desire to limit the length of time or number of times that the other person can use such digital content.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

In one aspect of the disclosed subject matter, a digital rights management (DRM) agent-server can be implemented in hardware. This can be done in a local environment between a limited number of parties (e.g., about two parties), where both sides are trusted. For example, an owner of digital content (e.g., video, music, multimedia, photograph, etc.) can send the digital content with a rights attachment and an agent can be trusted to carry out the required content protection. The content can be opened by an application agent that is utilized by the agent and only allows the receiving party or user to use the content in accordance with the rights granted to the user. The application agent can output the content to a presentation component, such as a display component or audio component, so that the user can perceive the content.

In another aspect of the disclosed subject matter, the application agent can be sent with the digital content to the user, and the application agent can facilitate the management of the rights to the digital content as well as the display of the digital content to the user. In another aspect, the rights attachment can be sent from the electronic device of the owner to the electronic device of the receiving party/user, and the user can download an application agent from a mutually trusted third party (e.g., Adobe® Reader® with DRM) to display the digital content, where the application agent allows the user to use the digital content in accordance with the rights granted via the rights attachment.

In yet another aspect, a system is provided wherein transfer of DRM content and rights is managed in a secure environment. The system can include an agent-server component that creates the secure environment. The agent-server component can comprise a control component that facilitates the security of data to and from memory, such as non-volatile memory and volatile memory. Furthermore, the non-volatile memory (e.g., flash memory) of the agent-server component can store security software for use by the control component. The control component can provide for concurrent processing of security protocols creating the secure environment within the agent-server component and can communicate with a server component and application agent component located within the agent-server component. The server component can communicate with another electronic device to transfer rights and digital content. According, the server component is located witin the agent-server component such that the transfer of content and rights is managed in the secure environment.

In yet another aspect, the agent-server can be implemented by an application-specific integrated circuit (ASIC) that can include all components associated with the agent-server, such as a control processing unit, memory, crypto logic, and an embedded agent-server in firmware, for example. Moreover, the agent-server can be implemented on a single integrated circuit chip, in accordance with one other aspect of the disclosed subject matter.

The following description and the annexed drawings set forth in detail certain illustrative aspects of the disclosed subject matter. These aspects are indicative, however, of but a few of the various ways in which the principles of the innovation may be employed and the disclosed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a system for management of rights to content in accordance with an aspect of the disclosed subject matter.

FIG. 2 illustrates a system that facilitates management of rights to content in accordance with an aspect of the disclosed subject matter.

FIG. 3 provides a more detailed depiction of an application agent in accordance with another aspect of the disclosed subject matter.

FIG. 4 provides a more detailed depiction of a use tracking component in accordance with another aspect of the disclosed subject matter.

FIG. 5 provides a more detailed block diagram of a server component that can be included with an aspect of the disclosed subject matter.

FIG. 6 provides a more detailed depiction of a processing component in accordance with the disclosed subject matter.

FIG. 7 illustrates a diagram of a cryptographic component in accordance with an aspect of the disclosed subject matter.

FIG. 8 illustrates a diagram of an authentication component in accordance with an aspect of the disclosed subject matter.

FIG. 9 illustrates a diagram of a partitioned memory in accordance with an aspect of the disclosed subject matter.

FIG. 10 illustrates a methodology for transferring content from an agent-server to an agent in accordance with an aspect of the subject matter disclosed herein.

FIG. 11 illustrates a methodology managing DRM rights in accordance with an aspect of the subject matter disclosed herein.

FIG. 12 is a schematic block diagram illustrating a suitable operating environment.

FIG. 13 is a schematic block diagram of a sample-computing environment.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Often, the owner of digital content (e.g., a photograph, music, video, multimedia, etc.) may wish to share such digital content with another by sending it from the electronic device of the owner to the electronic device of another person, but desires to prevent the other person from sending the digital content to a third entity and/or desires to limit the length of time or number of times the other person can use such digital content.

A digital rights management (DRM) agent-server can be implemented in hardware. This can be done in a local environment between a limited number of parties (e.g., two parties, three parties, etc.), where both/all sides are trusted. For example, an owner of digital content can send the digital content with a rights attachment and the agent can be trusted to carry out the required content protection. The content can be opened by an application agent that is utilized by the agent and only allows the user to use the content in accordance with the rights granted to the user. The application agent can output the content to a presentation component, such as a display component or audio component, so that a user can perceive the content.

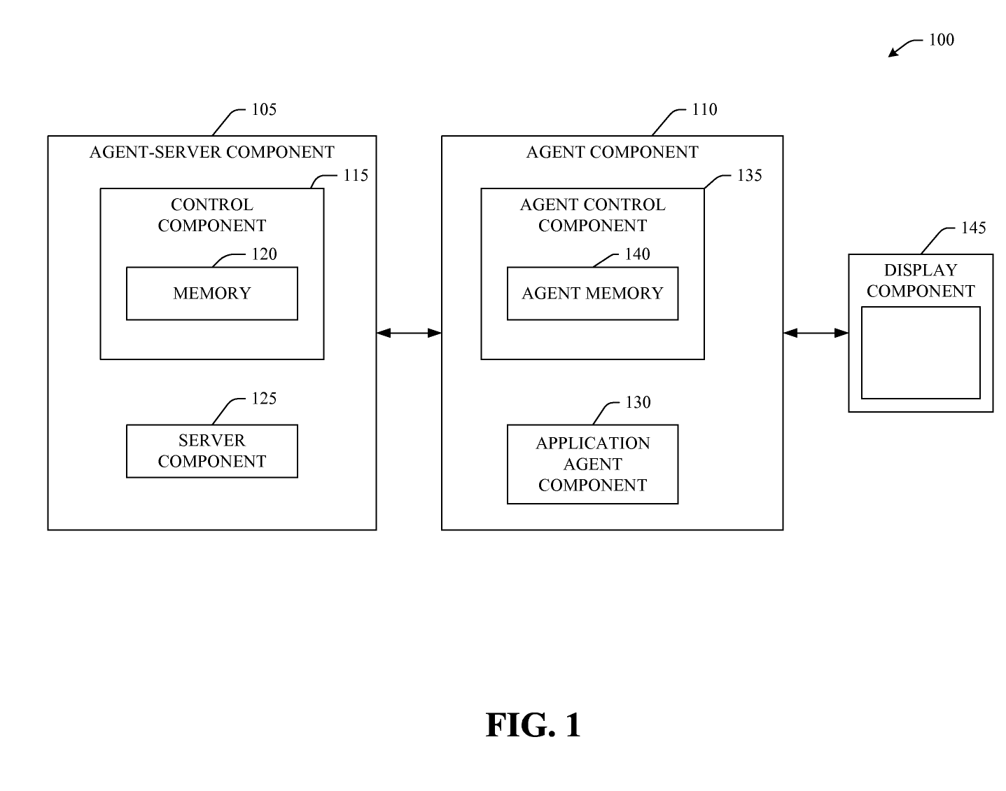

Now turning to FIG. 1, a system 100 for management of rights to content is illustrated. The system 100 can include an agent-server component 105 that can manage secure communication and control of digital content (e.g., music, photographs, video, multimedia) to an agent component 110 authorized by the agent-server component 105 to receive such content. Agent-server component 105 can include a control component 115 that can manage secure processing of information to and from memory 120 as well as facilitate management, including digital rights management, of digital content transferred to agent component 110. For example, the control component 115 can establish a secure link between the agent-server 105 and agent component 110 and extend its root of trust to DRM server component 125 and application agent component 130, which can be included in agent component 110 and is described in more detail below. DRM server component 125 can facilitate the generation and communication of an encrypted rights object and encrypted digital content to the agent component 110. In one aspect of the disclosed subject matter, the agent-server component 105, including the control component 115, memory 120, and DRM server component 125, can be situated on a single integrated circuit chip. In one another aspect of the disclosed subject matter, the agent-server component 105, including the control component 115, memory 120, and DRM server component 125, can be provided on an integrated circuit chip set with two or more chips.

Agent component 110 can include an agent control component 135 that can include an agent memory 140 which can store digital content transferred to the agent component 110 from the agent-server component 105. As stated, agent component 110 can also include an application agent component 130 that can manage the enforcement of rights associated with particular digital content transferred to the agent component 110 as well as facilitate the display of the digital content in a display component 145 that can be associated with the application agent component 140. Application agent component 130 can process data associated with the digital content, and make sure the digital content is used in accordance with the rights associated with the digital content, where such rights can be detailed in the rights object associated therewith. Such rights can include various parameters, such as the length of time the content can be used by the agent component 110, the number of times the content can be used by agent component 110, a limit or prohibition as to the distribution of the content to a third device, and/or a requirement that the application agent component 110 facilitate the automatic erasure or deletion of data associated with the digital content when the rights to such content have been exhausted. The DRM server component 125 and application agent component 130 can be matched pairs and can use the same language (e.g., eXtensible Markup Language (XML)) to describe the rights object.

The application agent 130 can be placed in the agent component 110 during manufacture. Alternatively, the application agent 130 can be sent from the agent-server component 105 and loaded into agent component 110. In another alternative, application agent 130 can be obtained (e.g., downloaded) from a mutually trusted third party (e.g., Adobe® Reader® with DRM).

The agent component 110, including the application agent component 130, agent control component 135, and agent memory 140 can be situated on a single integrated circuit chip. Alternatively, the agent component 110, including the application agent component 130, agent control component 135, and agent memory 140 can be situated on an integrated circuit chip set.

While not shown here, the agent-server component 105 can further include all components necessary to perform acts and functions typically associated with an agent, including acts and functions associated with agent component 110, and thus can act as an agent-type component when receiving information, such as digital content, from another server. Further, while not shown here, agent component 110 can further include all components necessary to perform acts and functions typically associated with a server, including acts and functions associated with agent-server component 105, and thus can act as a server when transferring information, such as digital content, to an agent-type component. The term “agent component” 110 is given, in part, to distinguish it from agent-server component 105 when discussing certain aspects of the disclosed subject matter.

The memory 120 and agent memory 140 can each include one or more volatile memory (e.g, random access memory (RAM), static RAM (SRAM), and the like) and non-volatile memory (e.g., read only memory (ROM), programmable ROM (PROM), flash, and the like). The memory 120 and agent memory 140 each can contain separate memory addresses to which data can be stored. Memory 120 and agent memory 140 each can also be partitioned into two or more partitions, which can be utilized to provide varying levels of security, for example. The respective partitions can be dynamic, as the partitions can either be fixed or programmable at run time.

For example, a user of a portable electronic device (e.g., a cellular phone, a laptop computer, a PDA, etc.) may desire to send music (e.g., a song) stored in the memory of the portable electronic device to an electronic device of another person, but may only want the other person to have limited rights of use to the music. Limited rights can include such limitations as only being able to listen to the song for a certain period of time, only being able to listen to the music a certain number of times, and/or prohibiting distribution of the music to other devices, for example, after which the owner of the music may want the music deleted from the electronic device of the other person.

In accordance with one aspect of the disclosed subject matter, the device of the content owner can contain an agent-server component 105. The agent-server component can include a control component 115 that can manage secure processing of information, including information associated with the music, to and from a memory 120 as well as facilitate management, including digital rights management, of digital content (e.g., music in digitized form) transferred to an agent component 110 included in the device of the other person. A DRM server component 125 can create a rights object detailing the rights granted to the other person with regard to the music. The DRM server component 125 can also encrypt the digital content and rights object. The encrypted content and rights object can be transferred to the electronic device of the other person, and can be received by the agent component 110. The device of the other person can then utilize an application agent component 130 to decrypt the content and rights, and the application agent component 130 can facilitate the use of the content while at the same time enforcing the rights granted by the content owner. Further, the rights object can specify when the content is to be automatically deleted from the agent memory 140 of the device of the other person by the application agent component 130, in accordance with the limits placed on the content by the content owner.

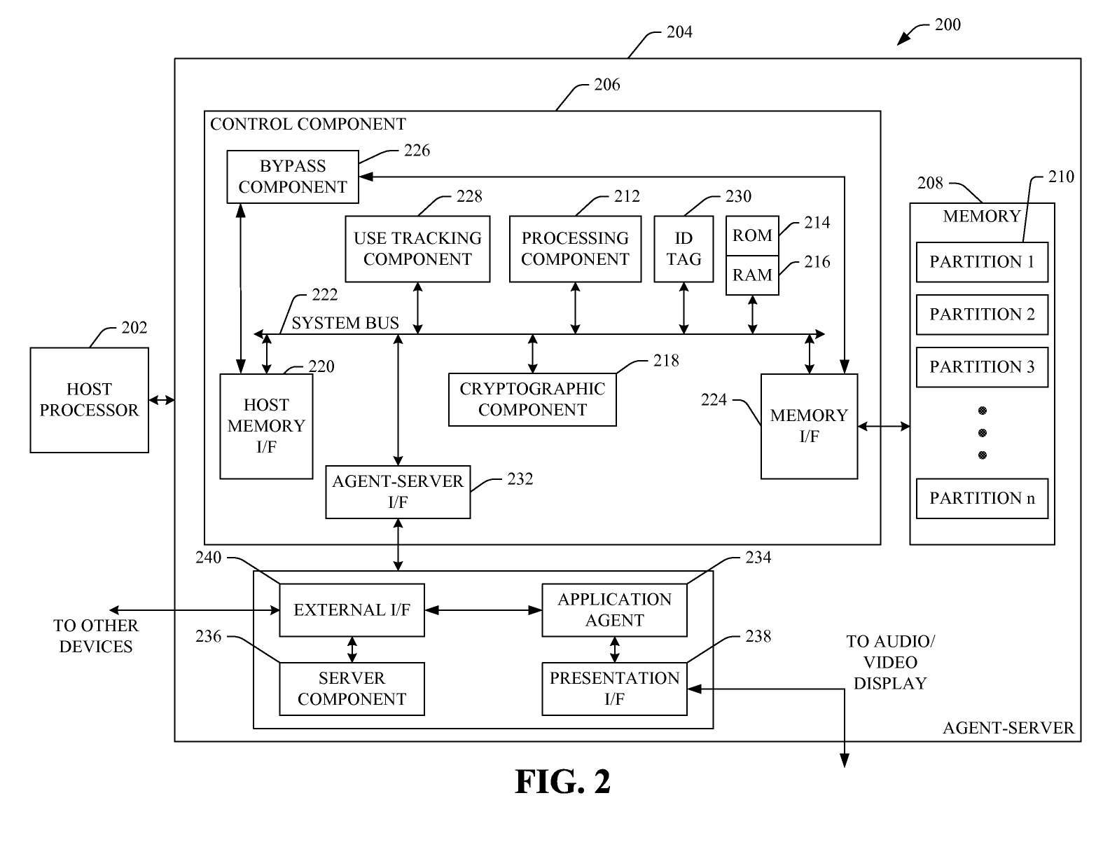

FIG. 2 illustrates a system 200 that facilitates management of rights to content. The system 200 can include a host processor 202, which can be a typical applications processor that handles communications and runs applications. The host processor 202 can be a baseband processor for a mobile handset, PDA, or the like. The host processor 202 can be associated with an agent-server component 204, which can include a control component 206 that can facilitate performing secure operations with regard to data transferred to and from memory 208. Control component 206 can also facilitate management of rights associated with digital content as data associated with digital content is communicated to an agent device (e.g., cellular phone, computer, PDA, etc.). The agent-server component 204 can be an ASIC and also can be situated on a single integrated circuit chip to enhance security of the data stored in memory 208. The host processor 202 can be connected in series with the control component 206 and memory 208 via a shared or split memory bus, such that the control component 206 is positioned in between the host processor 202 and memory 208 in the series connection.

The memory 208 can be comprised of one or more partitions 210. Further, the memory 208 can include one or more of volatile memory (e.g, RAM, SRAM, and the like) and non-volatile memory (e.g., ROM, PROM, flash, and the like). The partitions 210 can be dynamic, and can be fixed or programmable at run time, and the host processor 202 and control component 206 can each know to which partition 210 a particular memory location belongs based on the memory address associated with that memory location.

The agent-server component 204 can include security software including password authentication software, shared key authentication software, public key infrastructure (PKI) authentication software, integrity check software, encryption/decryption software, anti-virus software, anti-spyware software, secure communication software, and any other type of security software available. The security software can be directly embedded into the memory 208 to provide integrated security capabilities within the agent-server component 204. The control component 206 can access the security software from the memory 208 and perform security functions based on the specific security software stored. The control component 206 can control the entire memory storage and monitor all traffic to and from the memory 208 thereby enhancing the security of information stored in memory 208.

The agent-server component 204 can also provide for authentication services and secure channel communications based on this heightened level of security that is established. Authentication services and secure channel communications can be utilized in a variety of applications to create a secure environment. For example, the agent-server component 204 can provide security for secure partitioning, secure boot, virus rollback, firmware over the air update (FOTA), near field communication (NFC) secure payment, digital rights management, enterprise remote data management and mobile TV broadcasting.

Authentication services utilized by the agent-server component 204 can include password authentication, shared key authentication, and PKI authentication, for example. These authentication services can be used in association with three types of authentication. Type 1 can include authenticating a user to the secure memory 208, type 2 can include authenticating a host processor 202 to the secure memory 208, and type 3 can include authenticating a server to the secure memory 208. Further, authentication applications may require secure channel communications. The control component 204 can provide for two types of secure channel communications used in association with the authentication services. Type 1 can establish a secure channel of communication from a host processor 202 to the memory 208, and type 2 can establish a secure channel of communication from a back-end server to the memory 208.

The control component 206 can include a processing component 212 or any other type of low power application processor. The processing component 212 can provide a secure environment to implement authentication algorithms and security software. All timing associated with the reading or writing of data to the memory 208 by the control component 206 can be derived from and controlled by the host processor 202. Host processor 202 can generate read or write cycles associated with the control component 206 during cycles that the host processor 202 does not need access to the memory bus associated with memory 208. Further, host processor 202 and control component 206 can share access to the memory bus and thus the memory 208.

Processing component 212 can execute various applications that can facilitate and effectuate partitioning of the memory 208, ascertain whether access can be granted to entities requesting access to particular partitions, determine in concert with the host processor 202 whether authentication supplied by a requesting entity comports with corresponding authentication information that can be stored in associated ROM 214, RAM 216, and/or memory component 208, and can facilitate the encryption and decryption of data that is communicated between the host 202 and security processor 206 to ensure against phishing and man-in-the middle attacks, for example. In addition, processing component 212 can configure the cryptographic component 218, discussed in more detail, infra, and can control data flow through security processor 206. Further, the processing component 212 can facilitate management of rights associated with digital content.

While the host processor 202, control component 206, and memory 208 are shown configured in series, the host processor 202, control component 206, and memory 208 may be alternatively configured in any way that can facilitate the processing of data as described herein. Further, while, as shown, the host processor 202 arbitrates access to the memory 208 for the host processor 202 and control component 206, the memory 208, host processor 202, and control component 206 can be configured in any way that can facilitate the processing of data as described herein.

Control component 206 can also include a host memory I/F 220 that can be associated with system bus 222 and can handle all memory transactions with the host processor 202. Specifically, the host memory I/F 220 can manage signaling, thus complying with the interface definitions of the memory 208. The host memory I/F 220 also can manage interpreting or differentiating between a secure and non-secure request, and monitoring requests via enforcing access rights and permissions associated with the control component 206.

As stated, the control component 206 can include a cryptographic component 218 that can be associated with the system bus 222 and perform all the cryptographic algorithms, symmetric and asymmetric, or the like, needed by the system 200. The cryptographic component 218 can include one or more buffers (not shown) that can be utilized by the cryptographic component 218 when performing its operations. The processing component 212 can configure the cryptographic component 218 and control data flow through the control component 206. The cryptographic component 218 can encrypt data associated with digital content being transferred from agent-server component 204 to an agent or decrypt data associated with digital content being transferred to agent-server component 204 from a server.

The processing component 212 can interface the system bus 222 and the security applications that run on the processing component 212, arbitrating with the host processor 202. The control component 206 can also include a memory I/F 224 that can be associated with the system bus 222, and can handle all transactions to and from the memory 208, and the control component 206, such as signaling and interpretation.

The control component 206 can employ the processing component 212 to receive and retrieve authentication information (e.g., biometric information and/or password information) associated with an entity attempting to access one or more memory partitions. The authentication information can be used to determine which memory partitions, and thus, which memory addresses, in the memory 208 that the entity has authority to access.

The control component 206 can further employ a bypass component 226 that can be associated with the system bus 222, host memory I/F 220, and memory I/F 224, and when selected or enabled can allow data and other information to flow through it via system bus 222, so the host processor 202 can access the memory 208 directly without any processing or interference by the control component 206. The bypass component 226 can be a co-processor, for example, such as a simple co-processor that is able to receive memory address data, and select or enable the bypass mode when the memory address in the read/write cycle is associated with the host processor 202, or de-select or disable the bypass mode when the memory address is associated with the control component 206. In the bypass mode, the control component 206 is essentially “transparent” to the host processor 202 and memory 208, as the data and other information flows via the shared or split bus to/from the host processor 202, through the control component 206, via system bus 222 and from/to the memory 208 via the memory bus associated therewith. For example, the bypass component 226 can be selected or enabled to put the control component 206 into bypass mode when the host processor 202 is performing memory reads or writes associated with the host processor 202 that involve instructions, or data or other information that are not secured, such as with regard to application programs, etc.

When the bypass component 226 is de-selected or not enabled, the control component 206 can access the memory 208 via the shared memory bus. It is to be understood that the host processor 202 can provide the signal timing to both the control component 206 and memory 208 to control the access of the control component 206 to the memory bus, and thus the memory 208. Thus, the host processor 202 can control when data is moved in/out of the memory 208 from/to the security processor 206, as well as moved between internal components (e.g., cryptographic component 218) of the control component 206. An aspect of the disclosed subject matter is that the host processor 202 can “move” data to and from the memory 208 without the host processor 202 actually making a copy of the memory data. This architecture can thereby enhance the security of the system as well as simplify the design of the interface.

Control component 206 can also include a use tracking component 228 that can facilitate monitoring of the use of digital content and the enforcement of rights associated with digital content. Further, control component 206 can include ID Tag 230 that can be a unique identification (e.g., alphanumeric or numeric) that can be utilized to allow an agent or server device to identify the control component 206, which can allow the agent or server device to know whether the control component 206 (e.g. a device associated with the control component 206) can be trusted by the agent or server.

Control component 206 can further include an agent-server I/F 232 that can facilitate the transfer of information between application agent 234 and server component 236. Application agent 234 can process data associated with digital content and can ensure that the content is used in accordance with rights associated with the content which can be specified by the content provider. For example, when application agent 234 receives digital content, it can also receive a rights object that can specify what rights the agent-server component 204 has with regard to the content. Such rights can include various parameters, such as the length of time the server-agent component 204 can use the content, the number of times the content can be used, a limit or prohibition as to the distribution of the content to a third party, and/or a requirement that the content be deleted or erased when the use rights are exhausted. Further, application agent 234 can facilitate decryption of data associated with digital content sent to the application agent 234, so that such data can be perceived by the user via a presentation component (not shown).

Server component 236 can facilitate the generation and communication of an encrypted rights object and encrypted digital content to an agent device when agent-server component 204 is performing a server role. The server component 236 can encrypt the digital content to be sent to an agent, or alternatively, the content can be encrypted by the cryptographic component 218. For example, server component 236 can generate a rights object associated with digital content, and digital content that has been encrypted by cryptographic component 218. The rights object and encrypted digital content can be sent to an agent, where the trusted agent is only be able to use the content in accordance with the rights associated with the content.

Application agent 234 can also be associated with a presentation I/F 238 that can facilitate the communication of data associated with the digital content, so that the digital content can be presented to a user via the presentation component. To further ensure that the digital content is not used in a manner inconsistent with the rights associated therewith, the output from the application agent 234 can be in a format, such as that associated with raster vectors, that is not easily reproducible by the presentation component, such as a display monitor, for example.

Application agent 234 and server component 236 each can be associated with an external I/F 240, which can facilitate communication of data associated with digital content and rights associated therewith between the agent-server component 204 and another agent (or server). In one aspect of the disclosed subject matter, data can be communicated via a wired or wireless Internet or intranet connection. In another aspect of the disclosed subject matter, data can be communicated via Ultra-Wideband (UWB) or Bluetooth.

For example, the agent-server 204 can facilitate the transfer of content from the agent-server 204 to an agent in a local environment, where both sides are trusted. The owner of digital content (e.g., video, music, multimedia, photograph, etc.) can send the digital content with a rights attachment from the agent-server 204 to the agent, and the agent can be trusted to carry out the required content protection, as specified in the rights attachment (e.g., rights object). The agent-server 204 can be implemented in a portable electronic device (e.g., a cellular phone, a laptop computer, a PDA, etc.). The agent device can be an electronic device, such as a cellular phone, a computer, a PDA, an MP3 player, an iPod, a media player, etc., that is capable of using and presenting such content. The content can be opened by an application agent that is utilized by the agent device and only allows the user to use the content in accordance with the rights granted to the user by the content owner. The application agent can output the content to a presentation component, such as a display component or audio component, so that a user can perceive the content.

As further example, an owner of digital content, such as a photograph in digital form may desire to send the photograph stored in memory 208 on his cellular phone to a laptop computer of another person. The cellular phone of the content owner can contain an agent-server architecture, in accordance with the disclosed subject matter. The content owner can specify the rights the owner desires the other person to have with regard to the photograph, and can have the server component 236 in the agent-server 204 generate a rights object that contains information regarding the rights the owner is granting to the user as to the photograph. For example, the rights can include a length of time the other person can use or access the photograph on his agent device (e.g., laptop computer), the number of times the other person can open the photograph on his laptop computer, and/or deletion or erasure of the content from the memory of the laptop computer when the rights are exhausted or otherwise discontinued.

After the cellular phone of the owner and the laptop computer of the other person are mutually authenticated, which can be accomplished via authentication procedures, such as PKI authentication, as detailed herein, the transfer of data can be initiated between the two devices. The digital content and the rights object can then be encrypted by the server component 236 in the agent-server 204 and then transferred to the device of the other person. The rights object and content can be sent using a session key generated by the server component 236 of the agent-server 204, for example.

To open and use the content, the device of the other person needs an application agent that can decrypt the transferred data, enforce the rights as specified in the rights object, and facilitate presentation of the content in the display of the laptop computer. In one aspect, the application agent can be sent with the digital content to the user. In another aspect, the rights object can be sent from the device of the owner to the device of the other person, and the user can download an appropriate application agent from a mutually trusted third party (e.g., Adobe® Reader®) with DRM) to facilitate displaying the digital content, where the application agent can allow the user to use the digital content in accordance with the rights granted via the rights object.

Once the application agent is provided to the agent device, the application agent can be activated, and can return a signature to the server component 236. The server component 236 can verify intact receipt from the signature that the application agent software, digital content, rights object, and other information associated therewith, by the application agent. The control component 206 in the agent-server 204 can then send a decryption key to a control component in the laptop computer of the other person.

The application agent can then obtain the decryption key from the control component and decrypt the content and rights object. The application can facilitate the display of the photograph in the display of the laptop computer by outputting the decrypted content to the display. The application agent can also provide additional security that the rights are not be breached by the other person, as the application agent can output the decrypted content in a format, such as that associated with raster vectors, that is not easily reproducible.

The application system can work in conjunction with a use tracking component on the laptop computer to monitor the use of the content to enforce the rights associated therewith. Once the rights to the content is exhausted or discontinued, the application agent can cause the content to be automatically deleted from the memory of the laptop computer. Thus, the application agent can facilitate the use of the content while at the same time managing the rights granted by the content owner, even though the content owner does not have access to the agent device after the content is transferred.

In another aspect, the application agent can compute a new signature associated with the erased data image. This signature can be sent to the server component 236 as confirmation of the erasure. Thus, if additional data is to be sent after the erasure or deletion of previously transferred data, the server component 236 can be aware of the status of the previously sent data. Further, the server component 236 can have actual notice of the erasure of the content.

In yet another aspect, the agent-server 204 can be implemented by an ASIC that can include all components associated with the agent-server 204, such as the processing component 212, memory 208, cryptographic component 218, as it is implemented as an embedded agent-server in firmware, for example. Moreover, the agent-server 204 can be implemented on a single integrated circuit chip, or in a chip set, in accordance with one other aspect of the disclosed subject matter.

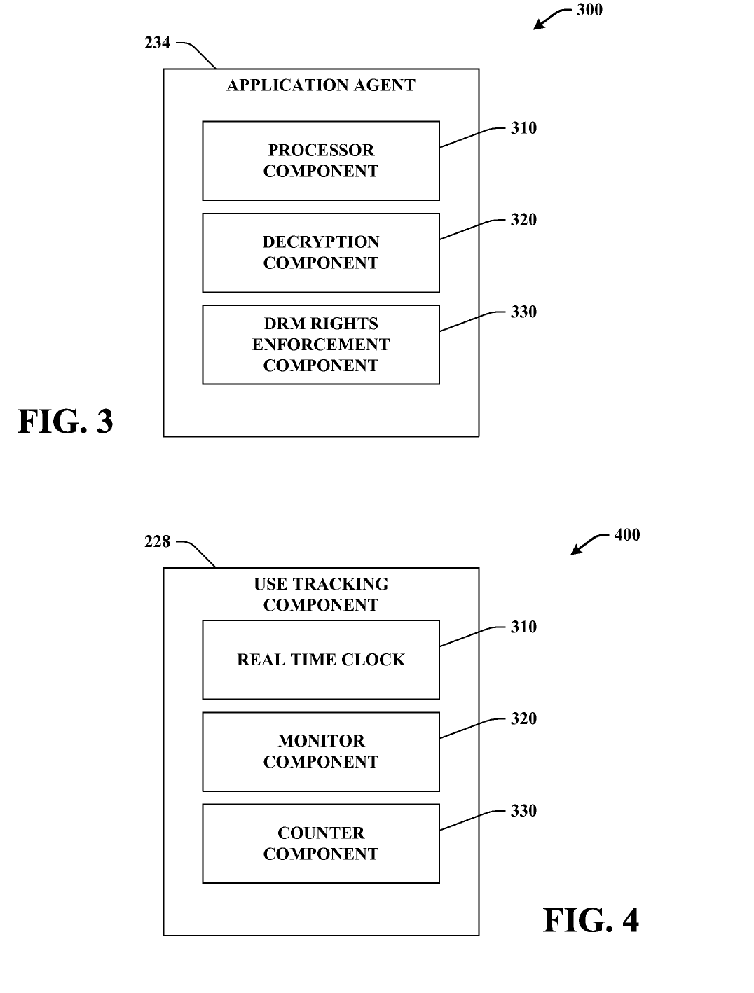

FIG. 3 provides a more detailed illustration 300 of the application agent 130 (and similarly 234) in more detail. The application agent 130 can include a processor component 310 that can process data associated with digital content and can operate in association with a decryption component 320 to decrypt the data facilitate the presentation of the digital content by a presentation component. For example, once the content and rights object is sent to application agent 130, and application agent 130 is activated and returns a signature to the agent-server component, the agent-server component can verify from the signature that the agent software and contents are intact. The agent-server component can then send a decryption key to the application agent 130 that can be used by the decryption component 320 in decrypting the content and rights object associated therewith.

Application agent 130 can also include a DRM rights enforcement component 330 that can ensure that the digital content is used by agent 110 (or similarly agent-server 204) in accordance with the rights associated with the content. For example, when a server sends digital content to agent 110, a rights object that can include information associated with the rights granted as to the digital content can be sent to the agent 110 as well. The DRM rights enforcement component 330 can analyze the rights object information and can ensure that the application agent 130 only permits use of the digital content consistent with the rights granted with regard to the content. The DRM rights enforcement component 330 can enforce various rights, such as the length of time the content can be used by the agent 110, and/or the number of times the content can be used, and/or deleting or erasing the content once the rights to the content are exhausted or the right to use the content is otherwise discontinued. Further, the DRM rights enforcement component 330 can receive information from the use tracking component 228, such as the length of time or number of times that content is used, and/or whether use rights are exhausted, to determine what course of action to take, if any, with regard to particular content.

FIG. 4 provides a more detailed depiction 400 of use tracking component 228. Illustrated therein use tracking component 228 can include a real time clock 410 that can be utilized to determine the amount of time that particular digital content has been used by agent 110 (and similarly agent-server 204). A monitor component 420 can be utilized to monitor the amount of time particular digital content is used to facilitate tracking of use time. Further, the use tracking component 228 can comprise a counter component 430 that can count the number of times particular digital content has been used. The monitor component 420 can monitor whether particular digital content is used, and can associate with the counter component 430, so that the counter component 430 can track the number of times that particular content is viewed. Use information associated with digital content can be communicated to the DRM rights enforcement component 330, so that component 330 can act accordingly.

For example, the rights object associated with particular digital content may specify that the digital content may only be viewed three times. The monitor component 420 can monitor the use of the digital content, and when the content is used, such information can be sent to the counter component 430. Once the content is used three times, the counter component 430 can communicate that information to the DRM rights enforcement component 330, which can act in accordance with the rights object information and prohibit further accessing of the digital content and further, can delete or erase the digital content from memory, if the rights object so provides.

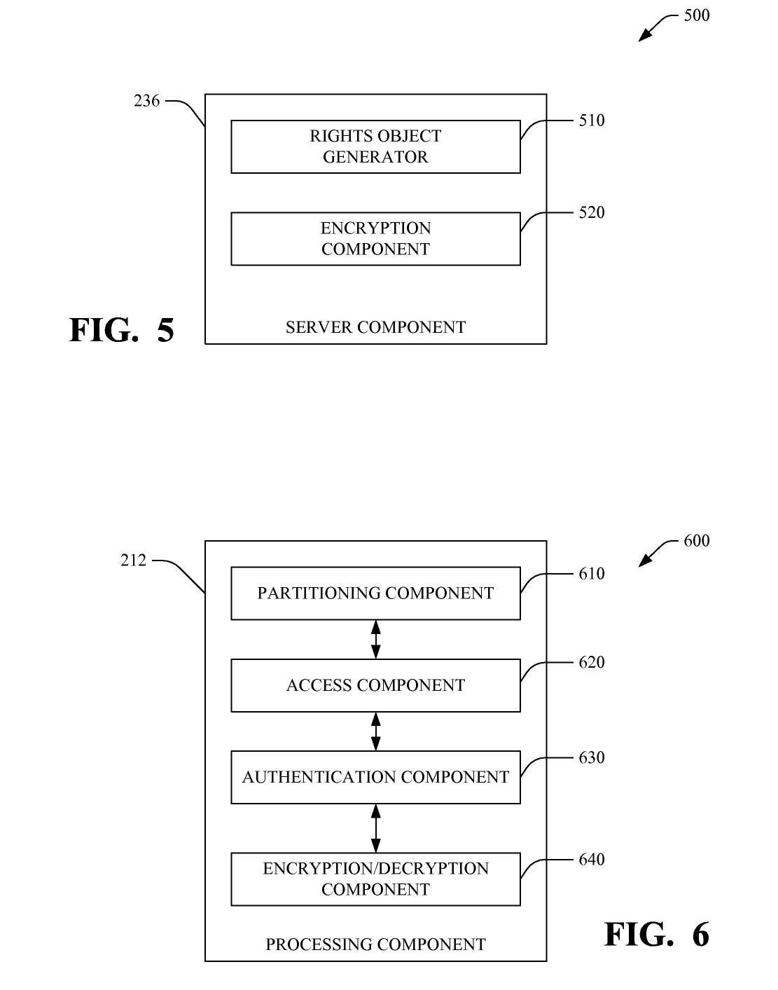

FIG. 5 provides a more detailed depiction 500 of server component 125. Server component 125 (and similarly 236) can include a rights object generator 510 that can generate a rights object that can contain information as to the rights granted with regard to digital content being transferred to an application agent of an agent device. For example, the rights object can include certain parameters, such as the length of time the content can be used by the agent device, how many times the content can be used by the agent device, and a requirement that the content be automatically erased or deleted once rights associated with the content have been exhausted or otherwise have been discontinued. The rights provided in the rights object can be enforced by the application agent. Server component 125 (and similarly 236) can further include an encryption component 520 that, in one aspect of the disclosed subject matter, can encrypt the digital content and rights object(s) being sent from the agent-server component to an agent device. In another aspect, the content and rights object(s) can be encrypted by a cryptographic component in the agent-server component.

FIG. 6 provides a more detailed depiction 600 of processing component 212. Illustrated therein processing component 212 can include a partitioning component 610 that can facilitate and effectuate partitioning of memory 208, an access component 620 that can ascertain and determine in concert with associated ROM 214 and/or RAM 216 and one or more internal registers (not shown) associated with agent-server component 204 whether or not an entity attempting to access a particular partition is assigned, or has appropriate, access rights to be granted access to that partition, an authentication component 630 that can elicit sufficient authentication information from an entity to ensure the identity of the entity requesting access to a particular partition, and an encryption/decryption component 640 that can facilitate the encryption/decryption of data communicated between the host processor 202 and the control component 206.

Partitioning component 610 can divide the memory component 208 into multiple partitions 210. A partition can be created by specifying an identifier (e.g., GUID) that can be associated with the location of the memory component 208, the start address from whence the partition 210 should commence, and an end address within the memory component 208. Since a created partition 210 can typically span over multiple erase units the start and end addresses can be rounded to erase units. Moreover, since a partition 210 can typically exist in one of two states, “open” or “closed”, partitioning component 610 can, upon appropriate command being issued, change the state. Thus, where a partition 210 is in an “open” state, partitioning component 610 can, upon receipt of a command and with proper authentication, close the partition. Conversely, where a partition is set to a “closed” state, partitioning component 610 can place the partition in an “open” state upon receipt of an appropriate command and with proper authentication.

Access component 620 can assign and determine access types and rights to partitions created by partitioning component 610. Typically access types that can be assigned by the access component 620 to a partition can include, but are not limited to, “read”, “write”, and “change access right”. Further, access component 620 can also assign and ascertain access permissions associated with a partition. Access permissions can include one of: “ALWAYS, WHEN_OPEN, WITH_PKI, or WHEN_{—OPEN}_OR_WITH PKI”, wherein access permission “ALWAYS” indicates that access to a partition is always allowed, “WHEN_OPEN” indicates that access to the partition is allowed only when a partition is in an “open” state, “WITH_PKI” denotes that access to a partition is permitted only when appropriate PKI authentication information has been supplied, and “WHEN_OPEN_OR_WITH PKI” connotes that access is allowed when a partition is in an “open” state or when appropriate PKI authentication information is supplied.

In addition, access component 620 can further set partition attributes on the “change access right” access type to: “ALWAYS”, “WITH_PASSWORD”, “WITH_PKI”, and “WITH_PASSWORD_OR_WITH PKI”, wherein a “change access right” attribute set to “ALWAYS” is indicative that access rights on a partition can always be changed, “WITH_PASSWORD” denotes that access rights can only be changed when an appropriate password is supplied by the entity requesting the change, “WITH_PKI” indicates that access rights to the partition can only be changed when appropriate PKI authentication information is supplied by the entity requesting the change, and “WITH_PASSWORD_OR_WITH_PKI” requires that the entity requesting the access change supply either an appropriate password or relevant PKI authentication information.

Authentication component 630 can receive and retrieve credential information (such as biometric information and/or password information) associated with an entity attempting to access one or more memory partitions. In addition authentication component 630 can manage and maintain credential information which can be stored in associated ROM 214 and/or RAM 216, and/or alternative such credential information can also be stored in one or more of the memory component 208. In addition to merely receiving credential information, authentication component 630 can also solicit additional credential information where the authentication component 630 deems such information may be necessary to appropriately establish the identity of the entity seeking access to a particular partition. Upon receipt of credential information from an entity, authentication component 630 can consult with stored credential information (e.g., in associated ROM 214, RAM 216, and/or memory component 208), and, upon identifying a correspondence between the supplied credential information and the stored credential information, can grant and/or indicate to access component 620 the appropriate access that should be accorded to the requesting entity.

Encryption/decryption component 640 can facilitate the utilization of one or more encryption/decryption facilities to ensure that communications between the control component 206 and the host processor 202 are not compromised by one of the many malicious extant viruses. The encryption/decryption component 640 can utilize one or more encryption/decryption mechanisms to obscure data communicated between control component 206 and the host processor 202. Examples of encryption/decryption mechanisms that can be employed to obscure the data can include utilization of hashing algorithms, public key encryption, elliptic curve encryption, and the like.

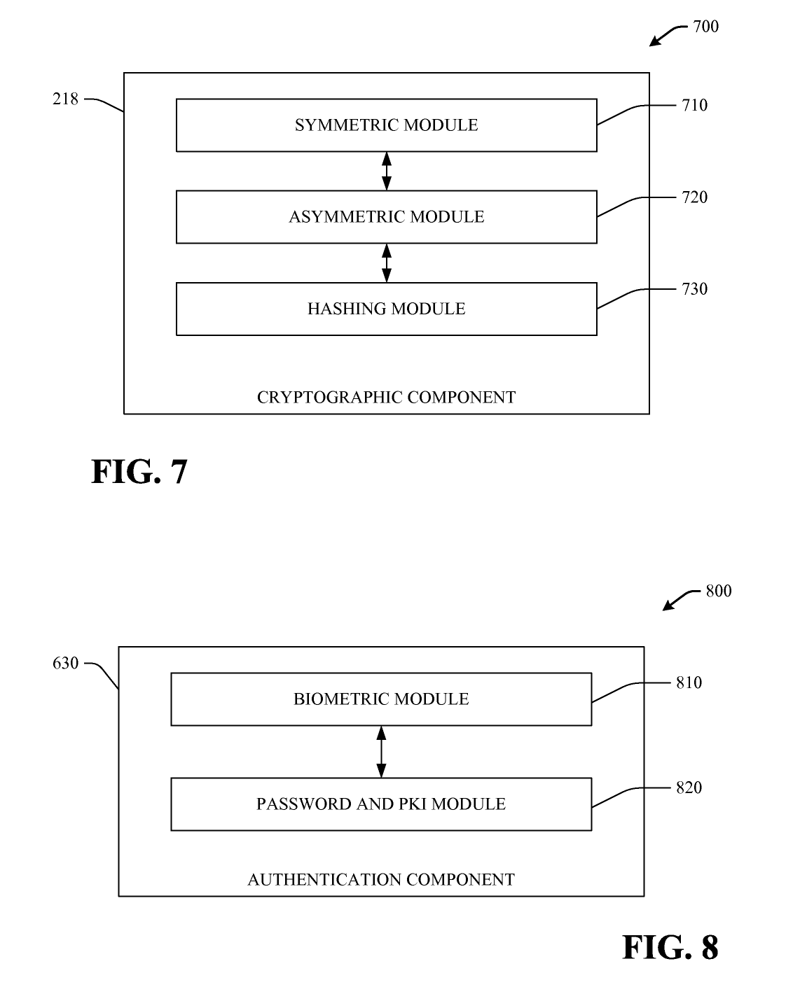

FIG. 7 provides a more detailed illustration 700 of cryptographic component 218. As illustrated, cryptographic component 218 can include symmetric module 710 that provides symmetric cryptographic tools and accelerators (e.g., Twofish, Blowfish, AES, TDES, IDEA, CAST5, RC4, etc.) to ensure that a specified partition in memory component 208, or portions thereof, can only be accessed by those entities authorized and/or authenticated to do so. Cryptographic component 218 can also include asymmetric module 720 that provides asymmetric cryptographic accelerators and tools (e.g., Diffie-Hellman, Digital Signature Standard (DSS), Elliptical Curve techniques, RSA, IKE, PGP, and the like) to ensure that a specified partition in memory component 208, or portions thereof, are only accessed by those entities that are authorized and certified to do so. Additionally, cryptographic component 218 can include hashing module 730 that, like symmetric module 710 and asymmetric module 720, can provide accelerators and tools (e.g., Secure Hash Algorithm (SHA) and its variants such as, for example, SHA-0, SHA-1, SHA-224, SHA-256, SHA-384, and SHA-512) to ensure that access to the specified partition in memory 208 is confined to those entities authorized to gain access.

Further, the cryptographic component 218 can be utilized to encrypt and decrypt data associated with digital content and a rights object associated therewith to facilitate the management of rights associated with such content as well as the security of such content.

FIG. 8 provides a more detailed depiction 800 of authentication component 630. Authentication component 630 can include a biometric module 810 and password and PKI module 820. Biometric module 810 can implement one or more machine implemented methods to identify an entity by its unique physical and behavioral characteristics and attributes. Biometric modalities that can be employed by biometric module 810 can include, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, voice recognition, and finger print identification that scans the corrugated ridges of skin that are non-continuous and form a pattern that can provide distinguishing features to identify an entity.

Password and PKI module 820 can solicit authentication data from an entity, and, upon the authentication data so solicited, can be employed, individually and/or in conjunction with information acquired and ascertained by the biometric module 810, to control access to memory 208. The authentication data can be in the form of a password (e.g. a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g. Personal Identification Number (PIN)), and the like. Additionally and alternatively, PKI data can also be employed by password and PKI module 820. PKI arrangements provide for trusted third parties to vet, and affirm, entity identity through the use of public keys that typically are certificates issued by the trusted third parties. Further, shared key authentication can be employed as well as any other type of authentication process available. Such arrangements enable entities to be authenticated to each other, and to use information in certificates (e.g., public keys) to encrypt and decrypt messages communicated between entities.

For example, an agent-server can be provided a private/public key pair from a certified authority (e.g., VeriSign®) during product manufacturing. Further an agent can be provided a private/public key pair from a certified authority during product manufacturing. If agent-server is intending to transfer digital content to the agent, PKI authentication can first be initiated and completed to ensure that the devices trust each other and the agent is the device to which agent-server wants to send the content.

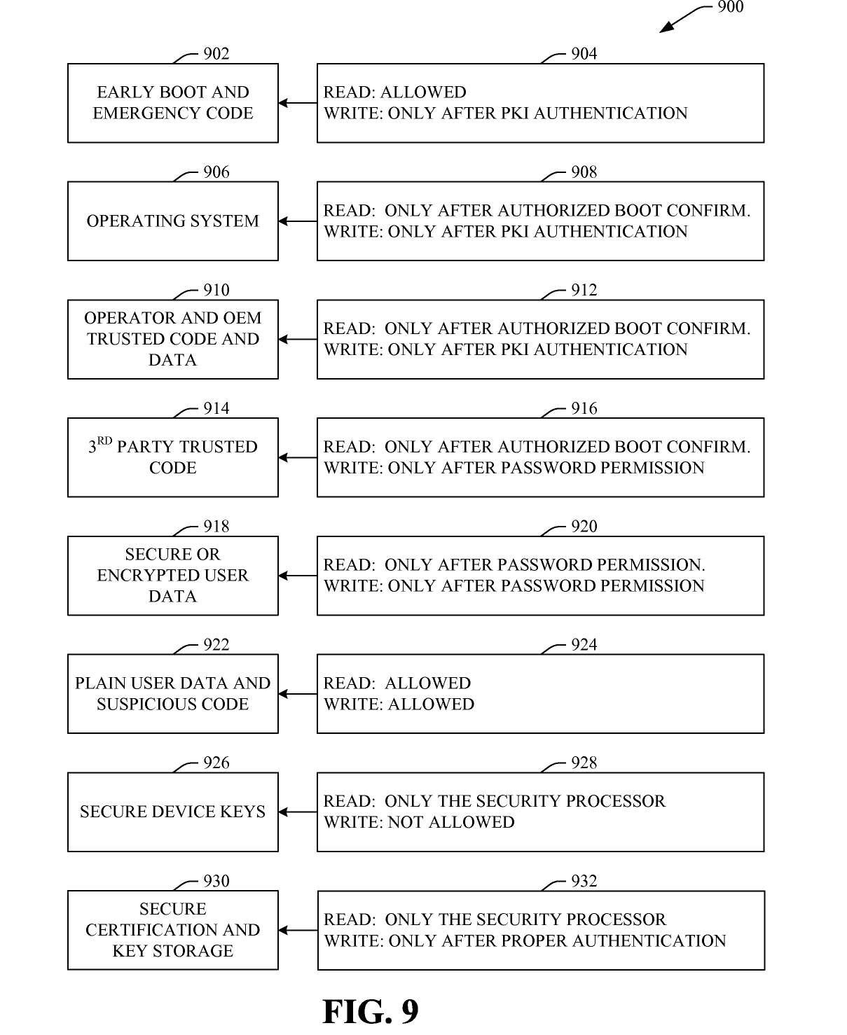

For example, FIG. 9 illustrates secure memory partitions 900 of a memory. The memory 208 can be one or more of volatile memory (e.g., RAM) or non-volatile memory (e.g., flash memory), for example. Secure Partitioning can be utilized to protect essential data and code, secure sensitive information, and allow easy access to common public data. Secure Partitioning can allow separate access controls to different partitions of data which can be made available based on user, service provider, original equipment manufacturer (OEM), enterprise authentication, or any other type of authentication available. More specifically, as illustrated in FIG. 9, the memory space can be divided into multiple partitions with associated access rights. The access rights can distinguish between read and write (or erase) permissions. The access rights can also include the ability to change access rights as permissions are granted and/or denied, so that multiple users who have access rights to a shared partition can all access the shared partition.

Further, the access rights can support different security levels of authentication. Accordingly, some objects can utilize higher levels of protection than others. For example, the partition that stores the operating system can be protected more securely than a partition that stores a downloaded game. The access rights can also support remote users who do not assume that the host is trusted. Authentication of a remote user must work correctly even if the host is not trusted. In addition to the access rights, partitions can be made inaccessible when an associated mobile handset is not in a trusted state.

As shown in FIG. 9, the memory 900 can be partitioned into eight segments. The memory 900 may be partitioned into as many segments as needed, limited to either software or hardware. Each partition can contain specific read/write (or erase) access rights as shown at the right of FIG. 9. Each partition can also contain an access right that specifies an entity that can change the read/write (erase) access rights.

Specifically, early boot and emergency code 902 includes access rights such that read access can be allowed but write (or erase) can be allowed only after PKI authentication 904. The operating system 906 can allow read access only after authorized boot confirmation and write (or erase) access only after PKI authentication 908. The operator and OEM trusted code and data 910 can allow read access only after authorized boot confirmation and write (or erase) access only after PKI authentication 912. Third party trusted code 914 can allow read access only after authorized boot confirmation and write (or erase) access only after User Password Permission 916. Secure or encrypted user data 918 can allow read and write (or erase) access only after user password permission is received 920.

Plain user data and suspicious code 922 can allow read and write (or erase) access without any security constraints 924. Secure device keys 926 can allow only the security processor (not shown) read access and can prohibit write (or erase) access 928. Secure certification and key storage 930 can allow only the security processor read access and allow write (or erase) access only after proper authentication 932. The read and write (or erase) security constraints disclosed in FIG. 9 are just some examples of security constraints that can be applied to the secure memory partitions of the memory, and any security constraints can be applied to the partitions depending on the security access required and/or requested. Furthermore, life-cycle stages can also control the security functionality access. Life-cycle stages include, but are not limited to, the manufacturing stage, development stage, vendor stage, service provider stage, secure (end user) stage and returned materials stage. For example, the life-cycle stages can exhibit a one-way flow wherein anything done on a previous stage is fixed once a stage transition occurs. Further, the main purpose of having life-cycle stages is to provide the flexibility needed during the pre-user stages and at the same time to enforce the security required during the end user stage.

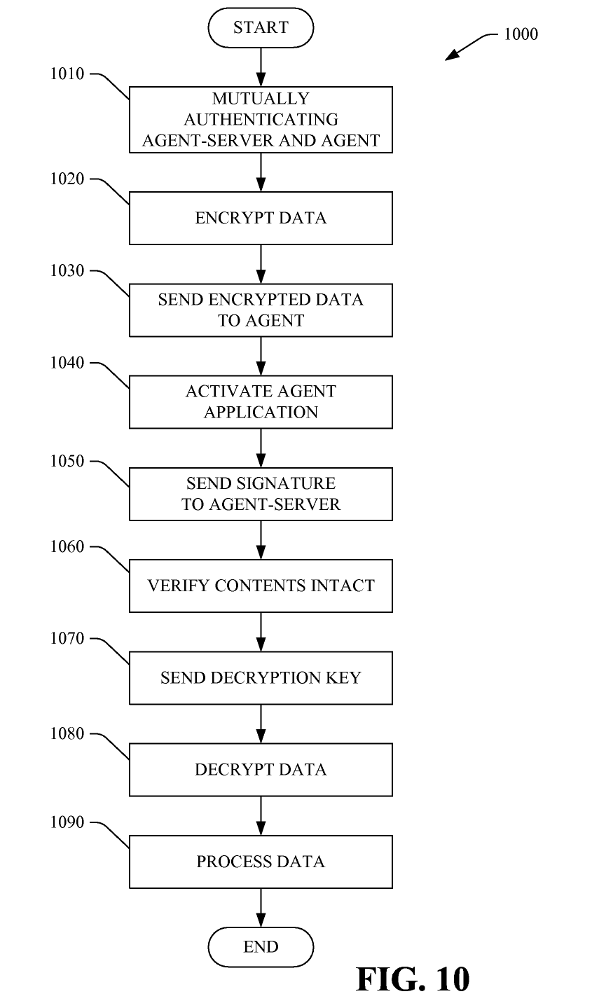

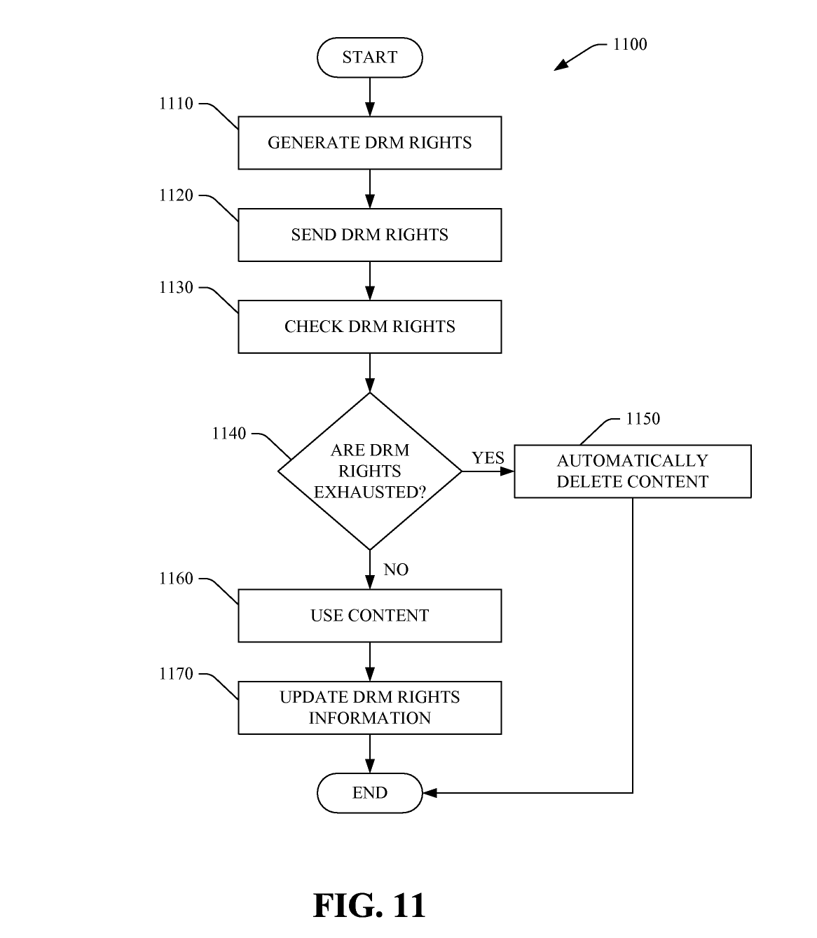

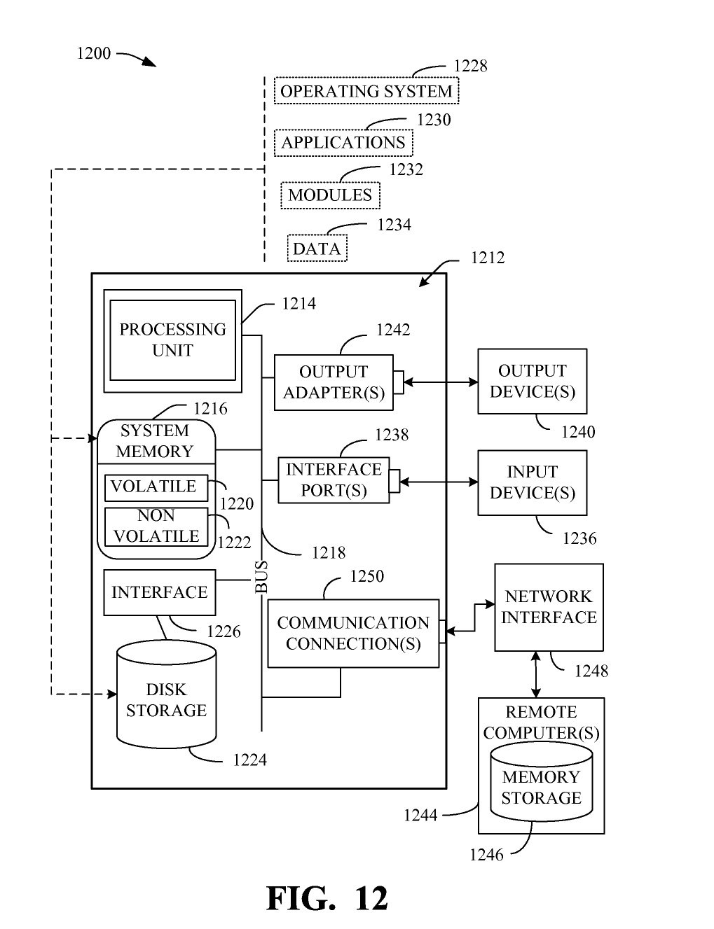

FIGS. 10-11 illustrate methodologies in accordance with the disclosed subject matter. For simplicity of explanation, the methodologies are depicted and described as a series of acts. However, the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art understand and appreciate that the methodologies could alternatively be represented as a series of interrelated states via a state diagram or events. Additionally, the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 10, a methodology 1000 for transferring content from an agent-server to an agent is illustrated. At 1010, an agent-server and an agent can be mutually authenticated so that each device is trusted by the other device. At 1020, the agent-server can generate a rights object that contains the DRM rights associated with the digital content to be transferred to the agent. At 1030, the agent-server can encrypt the digital content and the rights object associated therewith. For example, the agent-server can send the content and rights object to the agent using a session key generated by the agent-server. At 1040, an application agent in the agent can be activated. Once activated, at 1050, the agent can return a signature to the agent-server. At 1060, the agent-server can verify from the signature that the agent software, digital content, and rights object were delivered to the agent intact. At 1070, a decryption key can be sent from the agent-server to the agent. At 1080, the application agent of the agent device can decrypt the content and rights object associated therewith. At 1090, the application agent can process the data associated with the content and rights object and use the content in accordance with the rights granted to the agent by the agent-server, and enforce such DRM rights including deleting or erasing the content and other information associated therewith once the DRM rights have been exhausted or otherwise discontinued. At this point, the methodology 1000 may end.

Referring now to FIG. 11, a methodology 1100 for managing DRM rights is illustrated. At 1110, DRM rights associated with digital content can be generated by the agent-server. At 1120, the DRM rights (as a DRM rights object) and digital content can be sent from the agent-server to the agent. At 1130, when the application agent of the agent device attempts to open or access the digital content, the DRM rights can be checked to determine the DRM rights the application agent has to use the content. At 1140, a determination can be made as to whether the application has DRM rights to access, open, or use the content as intended. If the application agent has exhausted all DRM rights to the digital content, or if the DRM rights are otherwise discontinued, then at 1150, the digital content and other data associated therewith can be automatically deleted or erased from the agent device. If the application agent has DRM rights to use the digital content, then at 1160, the application agent of the agent device can use the content. At 1170, the agent can update information associated with the use of the content. For example, if the DRM rights are such that the application agent can only access the content a certain number of times, the agent can update a counter component that can keep track of the number of times that digital content is accessed by the application agent. As another example, if the DRM rights are such that the application agent has a specified amount of time to use the content, then the agent can monitor the amount of time that the content is accessed and update accordingly, or if the DRM rights specify a period of time from the first use, the time can be monitored so that use can be tracked and updated by a component in the agent device. At this point, the methodology 1100 may end.

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Artificial intelligence based systems (e.g. explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, a carrier wave can be employed to carry computer-readable electronic data such as those used in transmitting and receiving electronic mail or in accessing a network such as the Internet or a local area network (LAN). Of course, those skilled in the art recognize many modifications may be made to this configuration without departing from the scope or spirit of the disclosed subject matter.

Moreover, the word “exemplary” is used herein to mean serving as an example, instance, or illustration. Any aspect or design described herein as “exemplary” is not necessarily to be construed as preferred or advantageous over other aspects or designs.

It is proven convenient at times, principally for reasons of common usage, to refer to these signals as bits, values, elements, symbols, characters, terms, numbers, or the like. It should be borne in mind, however, that all of these and similar terms are associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

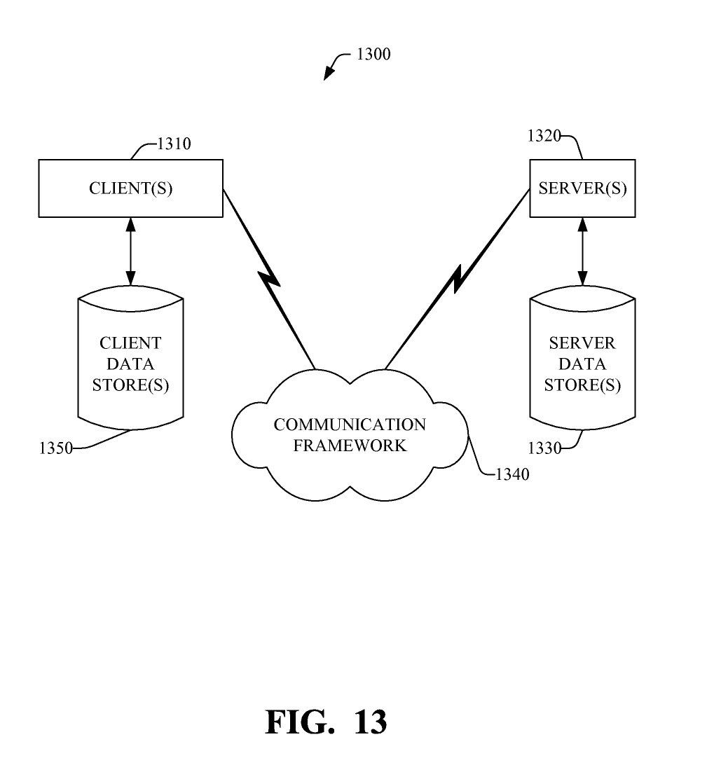

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter is described above in the general context of computer-executable instructions of a computer program that runs on a computer and/or computers, those skilled in the art recognize that the subject innovation also may be implemented in combination with other program modules. Generally, program modules include routines, programs, components, data structures, etc. that perform particular tasks and/or implement particular abstract data types. Moreover, those skilled in the art appreciate that the inventive methods may be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 12, a suitable environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include ROM, PROM, electrically programmable ROM (EPROM), electrically erasable programmable ROM (EEPROM), or flash memory. Volatile memory 1220 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example, a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used, such as interface 1226.

FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. The disclosed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. Other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1146 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A machine-implemented system that facilitates transfer of content and rights from an agent-server component to an agent component, comprising:
the agent-server component that transfers rights and content to the agent component, the agent-server component and the agent component are mutually authenticated; and
the agent component that uses a subset of the content in accordance with the rights associated with the content.

2. The system of claim 1, the agent component comprises an application agent that enforces the rights associated with the content, the application agent is received by the agent component from one of the agent-server component or an entity that is mutually trusted by the agent-server component and the agent component.

3. The system of claim 1, the agent-server component comprises an agent that receives content from a content provider and uses the content.

4. The system of claim 1, the rights comprise at least one of a length of time for use of the content, a number of times for use of the content, or automatic deletion of the content from a memory in the agent component.

5. The system of claim 1, the agent-server further comprises a server component that generates a rights object and transfers the rights object to the agent component, the rights object contains information associated with the rights associated with the content.

6. The system of claim 5, the rights object and the content are encrypted by the agent-server component prior to transferring the rights object and content to the agent component.

7. The system of claim 1, the agent-server component further comprises a memory, the memory is at least one of volatile memory or non-volatile memory.

8. The system of claim 7, the non-volatile memory comprises at least one of flash memory, read only memory, or programmable ROM.

9. The system of claim 1, the agent-server component is implemented in one of a cellular phone, an MP3 player, an iPod, a personal digital assistant, or a laptop computer.

10. The system of claim 1, the agent-server component comprises an application specific integrated circuit.

11. The system of claim 1, the agent-server component is implemented on a single integrated circuit chip.

12. A method for facilitating transfer of content and rights from an agent-server device to an agent device, comprising:
providing the agent-server device comprising an agent component and a server component;
mutually authenticating the agent-server device and the agent device;
transferring the content and the rights associated with the content from a memory in the agent-server device to the agent device; and
using the content in accordance with the rights granted by the agent-server device.

13. The method of claim 12, further comprising:
monitoring the use of the content; and
updating information associated with the use and the rights associated with the content; the monitoring and the updating are performed by the agent device.

14. The method of claim 12, further comprising:
enforcing the rights, the rights are enforced by the agent device; and
automatically deleting the content from the agent device when the agent device no longer has valid rights to the content.

15. The method of claim 14, further comprising:
automatically generating a signature associated with the content after deletion of the content; and
sending the signature to the server component.

16. The method of claim 12, further comprising:
at least one of transferring an application agent from the agent-server device to the agent device, or downloading the application agent from a mutually trusted third party.

17. The method of claim 16, further comprising:
encrypting the content and the rights prior to transferring the content and the rights to the agent device;
activating the application agent;
returning a signature associated with the content to the agent-server device;
verifying the content, the rights, and software associated with the application agent are intact;
transferring a decryption key from the agent-server device to the agent device, the decryption key is associated with the encryption associated with the content; and
decrypting the content and the rights.

18. The method of claim 12, the memory comprises at least one of volatile or non-volatile memory.

19. The method of claim 18, the non-volatile memory comprises at least one of flash memory, read only memory, or programmable ROM.

20. A system that facilitates transfer of content from an agent-server to an agent, comprising:
means for providing the agent-server;
means for communicating with the agent;
means for mutually authenticating the agent-server and the agent;
means for transferring content and rights associated with the content to the agent;
means for monitoring the use of the content by the agent;
means for enforcing the rights associated with the content; and
means for automatically deleting the content from the agent when the rights associated with the content are exhausted or discontinued.
